(19) United States
(12) Patent Application Publication
(10) Pub. No.: US 2005/0046215 A1
(43) Pub. Date: Mar. 3, 2005

(54) Mounting structure of a vehicle subframe

(76) Inventor: Ho Gie Chung, Suwon-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/747,895

(22) Filed: Dec. 29, 2003

(30) Foreign Application Priority Data
Aug. 26, 2003 (KR) 10-2003-0059280

(51) Int. Cl. B62D 27/00

(52) U.S. Cl. 296/29

(57) ABSTRACT

A vehicle subframe mounting structure has an upper member and a gusset welded to lower surface of the upper member. A pipe nut is disposed between the upper member and the gusset and connected to a bolt assembly at the bottom portion thereof. A reinforcing member has a hole for inserting the pipe nut and is partially welded to the pipe nut. An O-ring shaped seal member is disposed on an upper surface of the reinforcing member around the circumference of the pipe nut, wherein a flange portion is formed around the hole of the reinforcing member, and a recess is formed on the lower surface of the pipe nut for receiving the O-ring shaped seal member and the flange portion.

### CROSS-REFERENCE TO RELATED APPLICATIONS

This application claims priority of Korean Application No. 10-2003-0059280, filed on Aug. 26, 2003, the disclosure of which is incorporated fully herein by reference.

### FIELD OF THE INVENTION

Generally, the present invention relates to a vehicle subframe mounting structure. More particularly, the mounting structure prevents corrosion and enhances durability.

### BACKGROUND OF THE INVENTION

Generally, vehicles include a chassis, which constitutes a main skeleton and have a plurality of panels attached to the chassis frame. A subframe is a part of the chassis that is disposed toward a bottom portion of an engine compartment and supports a plurality of components. Typically the subframe is transversely connected and fixed to a pair of side frames, which extend longitudinally with respect to the vehicle.

In a conventional mounting structure of the subframe, each comer portion of the subframe is mounted on a side frame by a bolt assembly 20. The subframe is provided with an upper member and a gusset welded to a lower surface of the upper member. A pipe nut is disposed between the upper panel and the gusset and protrudes through the bottom portion of the gusset. A reinforcing member is then inserted between the pipe nut and the upper surface of the gusset, and the reinforcing member is fixed to the pipe nut and the upper surface of the gusset by welding.

However, often the seal between the circumferential portion of the pipe nut and the reinforce member is not perfect, such that water permeates into a slit such that the circumferential portion of the pipe nut becomes corroded. Accordingly, the bolt can not be securely connected into the protruding portion of the pipe nut.

### SUMMARY OF THE INVENTION

An objective of the invention is to provide a mounting structure of a subframe that minimizes corrosion resulting from permeated water and, therefore, enhances durability.

An exemplary mounting structure comprises a subframe having an upper member with a gusset welded to a lower surface of the subframe. A pipe nut is disposed between the upper member and the gusset and connected to a bolt assembly at the bottom portion thereof. A reinforcing member has a hole for inserting the pipe nut, interposed between the upper surface of the gusset and the pipe nut, and is partially welded to the pipe nut. An O-ring seal member is disposed on the upper surface of the reinforcing member around the circumference of the pipe nut, wherein a flange portion is formed around the hole of the reinforcing member, and a recess is formed on the lower surface of the pipe nut for receiving the O-ring seal and the flange portion.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 is a perspective view of a subframe of a vehicle; and

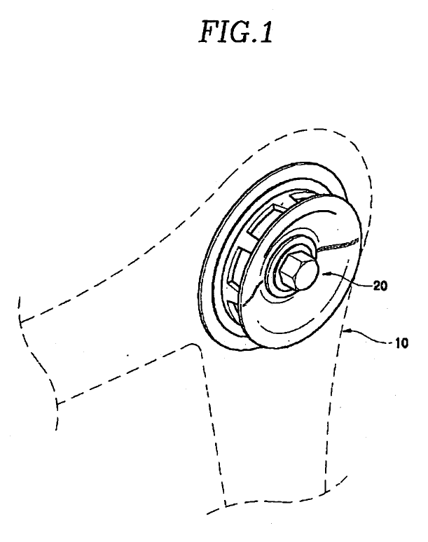

FIG. 2 is a sectional view of an embodiment of a mounting structure of a subframe of a vehicle according to an embodiment of the present invention.

### DETAILED DESCRIPTION OF A PREFERRED EMBODIMENT

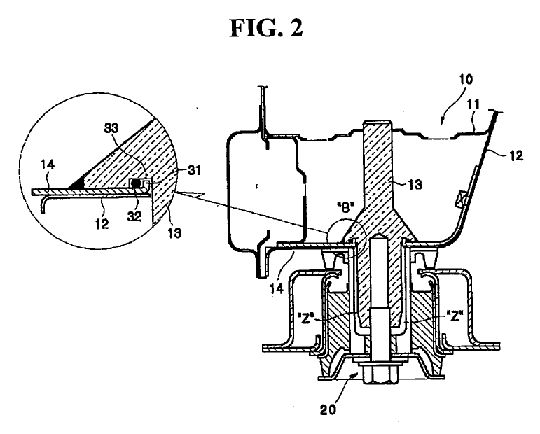

FIG. 2 is a sectional view of an embodiment of a mounting structure of a vehicle subframe. As shown in FIG. 2, a subframe 10 has an upper member 11 and a gusset 12 such that the upper member 11 is coupled to the gusset 12. According to a preferred embodiment, the upper member 11 is welded to the gusset 12. A pipe nut 13 is positioned between the upper member 11 and the gusset 12 for connecting a bolt assembly 20. The bolt assembly 20 is fixed to the pipe nut 12 at the bottom portion thereof.

A reinforcing member 14 is interposed between the upper surface of the gusset 12 and the protruding portion which is formed around the pipe nut 13. The reinforcing member 14 is partially welded to the upper surface of the gusset 12 in a preferred embodiment. The reinforcing member 14 has a hole for inserting the bolt assembly 20 such that a flange portion 31 is formed around the hole in the direction of the protruding portion of the pipe nut 13. Furthermore, an O-ring seal member 32 is disposed on the reinforcing member 14 around the circumference of the flange portion 31.

Around the lower surface of the protruding portion of the pipe nut 13, a recess 33 is formed such that the O-ring seal member 32 and the flange portion 31 are received into the recess 33. Accordingly, a seal in the slit, denoted as “B,” is formed owing to the O-ring seal member 32, the flange portion 31, and the recess 33. Therefore, water is prevented from permeating into the slit and corrosion of the circumferential portion of the pipe nut 12, denoted as “Z”, is also minimized.

1. A mounting structure of a subframe of a vehicle, comprising:
a subframe having an upper member and a gusset welded to a lower surface of the upper member;
a pipe nut disposed between the upper member and the gusset and connected to a bolt assembly at a bottom portion thereof;
a reinforcing member having a hole for inserting the pipe nut interposed between an upper surface of the gusset and partially welded to the pipe nut; and
an O-ring seal member disposed on an upper surface of the reinforcing member circumferencially around the pipe nut,
wherein a flange portion is formed around the hole of the reinforcing member and a recess is formed on a lower surface of the pipe nut for receiving the O-ring seal member and the flange portion.

2. A mounting structure of a subframe of a vehicle, comprising:
a subframe having an upper member and a gusset coupled with a lower surface of the upper member;
a pipe nut disposed between the upper member and the gusset and connected to a bolt assembly;
a reinforcing member coupled with the gusset and defining an opening for receiving the pipe nut; and
an O-ring seal member disposed on an upper surface of the reinforcing member circumferencially around the pipe nut,
wherein a flange portion is formed around the opening for receiving the pipe nut and a recess is formed on a lower surface of the pipe nut for receiving the O-ring seal member and the flange portion.
